(19) United States
(12) Patent Application Publication
(10) Pub. No.: US 2023/0415312 A1
(43) Pub. Date: Dec. 28, 2023

(54) TORSION TOOL

(71) Applicant: CHIAO FA Machinery Co., Ltd., Taichung City (TW)

(72) Inventor: YU-CHING LIN, Taichung City (TW)

(21) Appl. No.: 17/848,260

(22) Filed: Jun. 23, 2022

(51) Int. Cl. B25B 23/14; B25B 23/00

(52) U.S. Cl. CPC B25B 23/141; B25B 23/0035; B25B 23/1427

(57) ABSTRACT

A torsion tool is provided, including: a barrel; a first member disposed at one end of the barrel, including at least one first engaging portion; a second member, disposed in the barrel, including at least one second engaging portion releasably engaged with the at least one first engaging portion; an elastic mechanism, including a first fixation portion disposed in the barrel and elastic arms, the elastic arms being independently fixed to the first fixation portion and corresponding to each other, the second member being located between and configured to radially expand the elastic arms; wherein as the second member urges and radially expands the elastic arms, the at least one second engaging portion and the at least one first engaging portion are relatively slipable and disengageable.

### BACKGROUND OF THE INVENTION

### Field of the Invention

The present invention relates to a torsion tool.

### Description of the Prior Art

Generally, socket tools are often used for disassembling and assembling workpieces such as screws, nuts, etc. However, the conventional socket tool cannot apply constant torque to a workpiece during operation, and thus it is difficult for users to control the torque applied to the workpiece, thus causing inconvenience in disassembly and assembly, and thus damaging the workpiece easily.

Therefore, torsion tools are provided, accordingly. A main body of the conventional torsion tool is provided with a driving head, and the main body of the torsion tool includes a torque-adjusting mechanism for controlling applying torque within a set range so as to avoid damage to the workpiece. However, the torque-adjusting mechanism of the conventional torsion tools can only provide a limited range of torque control, which narrows the applications for assembling/disassembling. Furthermore, the torque-adjusting mechanism of the conventional torsion tool is easy to be damaged or broken.

The present invention is, therefore, arisen to obviate or at least mitigate the above-mentioned disadvantages.

### SUMMARY OF THE INVENTION

The main object of the present invention is to provide a torsion tool which can avoid damage to driven piece or workpiece.

To achieve the above and other objects, a torsion tool is provided, including: a barrel; a first member disposed at one end of the barrel, including at least one first engaging portion; a second member, disposed in the barrel, including at least one second engaging portion, on a motion path of the second member, the at least one second engaging portion and the at least one first engaging portion being releasably engaged with each other; an elastic mechanism, including a first fixation portion disposed in the barrel and a plurality of elastic arms, the plurality of elastic arms being independently fixed to the first fixation portion and corresponding to each other, the second member being located between and configured to radially expand the plurality of elastic arms; wherein when there is a torsion force greater than a preset torque value between the at least one second engaging portion and the at least one first engaging portion, the second member urges and radially expands the plurality of elastic arms so that the at least one second engaging portion and the at least one first engaging portion are relatively slipable and disengageable.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a breakdown drawing of the first preferable embodiment of the present invention;

FIG. 3 is a cross-sectional view showing a torsion tool in an engaged state according the first preferable embodiment of the present invention;

FIG. 4 is a cross-sectional view showing the torsion tool in a disengaged state according the first preferable embodiment of the present invention;

FIG. 5 is another breakdown drawing of an abutting member according to the first preferable embodiment of the present invention;

FIG. 6 is another breakdown drawing of the first preferable embodiment of the present invention;

FIG. 7 is a stereogram of a second preferable embodiment of the present invention;

FIG. 8 is a breakdown drawing of the second preferable embodiment of the present invention;

FIG. 9 is a partial cross-sectional view of the second preferable embodiment of the present invention; and

FIG. 10 is an enlargement of FIG. 9.

### DETAILED DESCRIPTION OF THE PREFERRED EMBODIMENTS

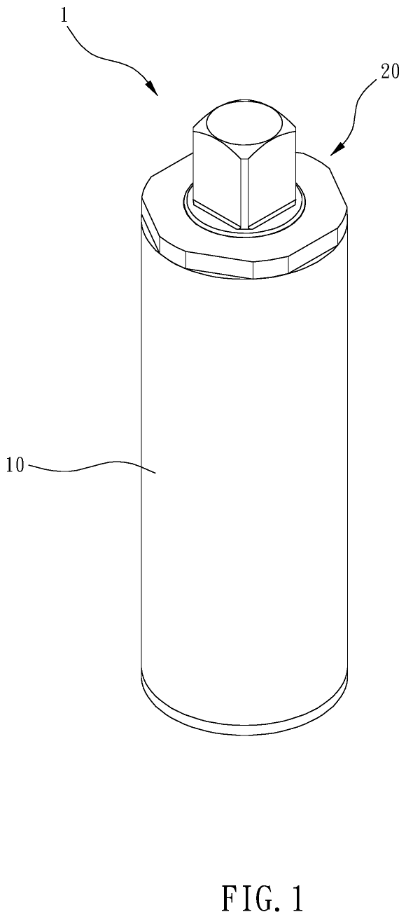

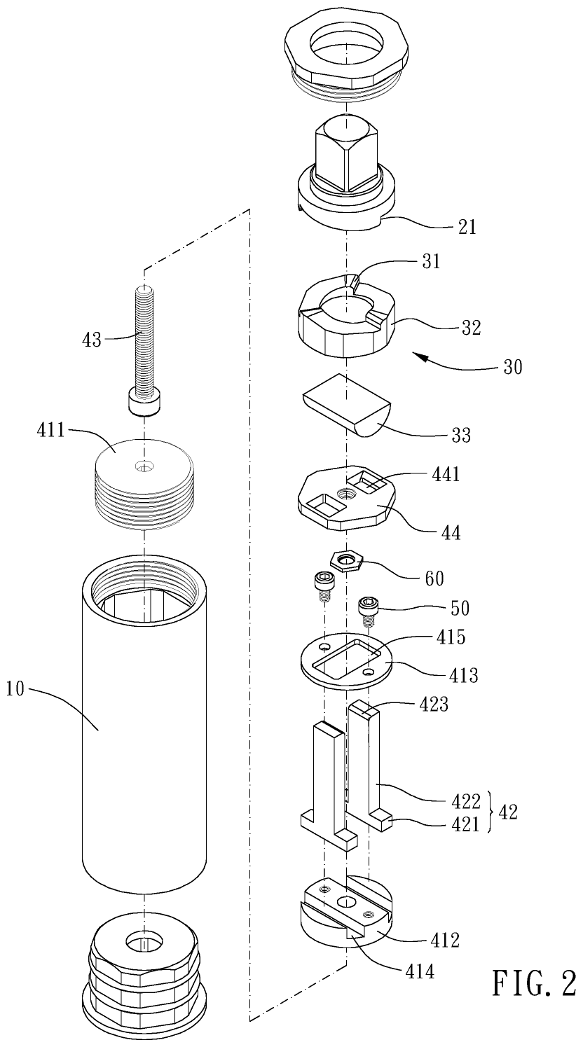

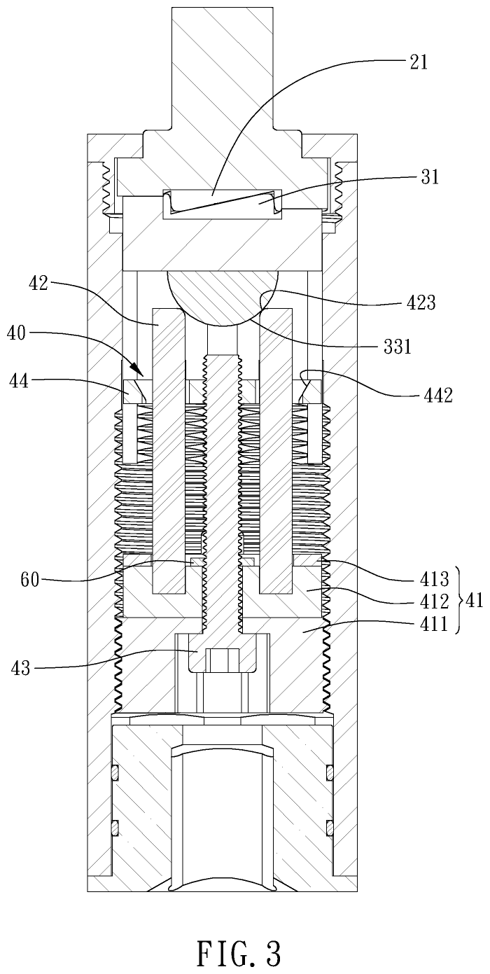

Please refer to FIGS. 1 to 4 for a first preferable embodiment of the present invention. A torsion tool 1 of the present invention includes a barrel 10, a first member 20, a second member 30 and an elastic mechanism 40.

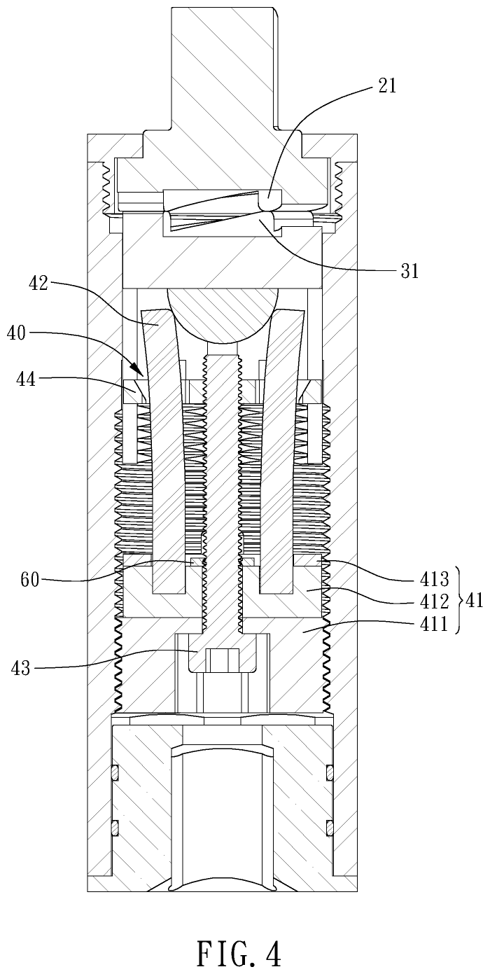

The first member 20 is disposed at one end of the barrel 10, and the first member 20 includes at least one first engaging portion 21. The second member 30 is disposed in the barrel 10, and the second member 30 includes at least one second engaging portion 31. On a motion path of the second member 30, the at least one second engaging portion 31 and the at least one first engaging portion 21 are releasably engaged with each other. The elastic mechanism 40 includes a first fixation portion 41 disposed in the barrel 10 and a plurality of elastic arms 42, the plurality of elastic arms 42 are independently fixed to the first fixation portion 41 and correspond to each other, and the second member 30 is located between and configured to radially expand the plurality of elastic arms 42. When there is a torsion force greater than a preset torque value between the at least one second engaging portion 31 and the at least one first engaging portion 21, the second member urges and radially expands the plurality of elastic arms 42 so that the at least one second engaging portion 31 and the at least one first engaging portion 21 are relatively slipable and disengageable (FIG. 4), which can avoid damage to driven piece or workpiece. The at least one first engaging portion 21 and the at least one second engaging portion 31 may be configured to be cooperative inclined faces, arcuate faces or the like.

In this embodiment, the first member 20 is detachably assembled to the barrel 10, which is easy to exchange or cooperate with a tool of suitable size, type or/and function. Preferably, an end of the first member 20 is tetragonal or non-circular, for connection of a tool such as a socket tool; another end of the torsion tool 1 is configured to be connected to a rotational shaft of a driving tool (such as hand tool or power tool).

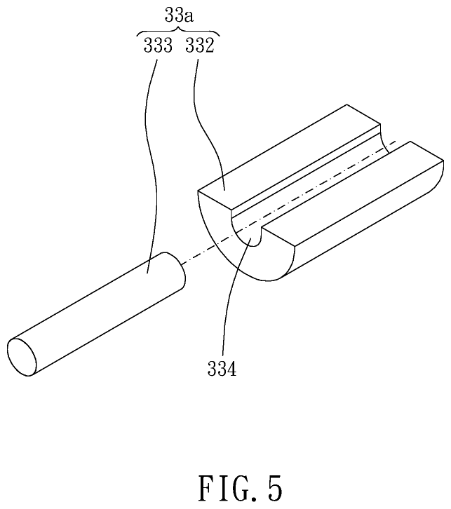

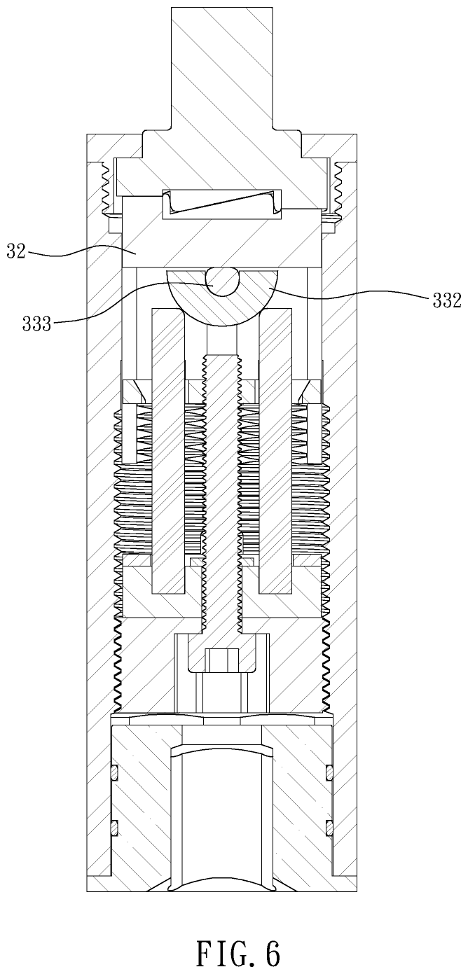

The second member 30 includes an engaging member 32 including the at least one second engaging portion 31 and an abutting member 33 abutted between the engaging member 32 and the plurality of elastic arms 42, and the abutting member 33 is located between and configured to radially expand the plurality of elastic arms 42. Preferably, the abutting member 33 includes an arcuate surface 331 extending between the plurality of elastic arms 42. For example, the arcuate surface 331 is an arced surface, which lowers the friction, improves operation and urges the plurality of elastic arms 42 evenly. The abutting member 33 is detachably abutted against the engaging member 32 (by contact, screwing, buckling, snapping or the like, for example). In an alternative embodiment as shown in FIGS. 5 and 6, the abutting member 33a includes an abutting body 332 and an elastic body 333 attached to the abutting body 332. For example, the abutting body 332 includes a recess 334, and the elastic body 333 is partially received within the recess 334. The elastic body 333 may be made of rubber or any of other elastic materials, which provides buffering between the engaging member 32 and the abutting body 332 which are in contact or not in contact, and avoids and absorbs impact.

In this embodiment, the first fixation portion 41 includes a first fixation member 411 connected to the barrel 10, a base 412 located at a side of the first fixation member 411 and a pressing member 413 fixedly connected to the base 412. Each of the plurality of elastic arms 42 includes a lateral section 421 received in the base 412 and clamped between the pressing member 413 and the base 412, so that it is easy to manufacture and assemble/disassemble and has a stable and strong structure. Each of the plurality of elastic arms 42 further includes an upright section 422 extending toward the second member 30 and abutting the second member 30, and the lateral section 421 extends laterally from the upright section 422 to be in T-shaped, L-shaped, cross-shaped or the like. Preferably, the lateral section 421 extends laterally in opposite directions from the upright section 422, which enhances the combination of the plurality of elastic arms 42 and the base 412 so that the plurality of elastic arms 42 are not easy to be broken.

Specifically, the base 412 includes a plurality of grooves 414 arranged in parallel, and the lateral section of each of the plurality of elastic arms 421 is received in one of the plurality of grooves 414 and flush with the base 412 so that the plurality of elastic arms 42 can be expanded evenly and the preset torque value which is more precise can be obtained. At least one or a plurality of fasteners 50 fix the pressing member 413 to the base 412, which is stable and easy to assemble/disassemble. The pressing member 413 includes a penetrating hole 415, and the plurality of elastic arms 42 and the threaded member are disposed through the penetrating hole 415.

The elastic mechanism 40 further includes a threaded member 43 and a plate member 44, and the threaded member 43 is disposed through the first fixation member 411, the base 412 and the pressing member 413. The plurality of elastic arms 42 extend toward the second member 30 and extend through and project beyond the plate member 44. The threaded member 43 is screwed to the plate member 44, thus allowing adjustment to have various protrusion level of the plurality of elastic arms 42 beyond the plate member 44. The plate member 44 includes a plurality of through holes 441 through which the plurality of elastic arms 42 are disposed, and each of the plurality of through holes 441 includes an inclined surface 442 located between one of the plurality of elastic arms 42 and the barrel 10 and the barrel and expands upward, which provides a space allowing movement of the elastic arm 42 urged radially. Preferably, the elastic mechanism 40 further includes a nut 60 screwed to the threaded member 43, and the nut 60 is located between the plate member 44 and the base 412, so that the threaded member 43 is kept to be with the first fixation portion 41 as detached from the plate member 44. The nut 60 is thinner than the pressing member 413 and is located in the penetrating hole 415, and thus it does not affect the travel distance of the plate member 44 on the threaded member 43. Each of the plurality of elastic arms 42 includes a corner portion 423 abutted against the second member 30 so that the plurality of elastic arms 42 can be expanded evenly and smoothly.

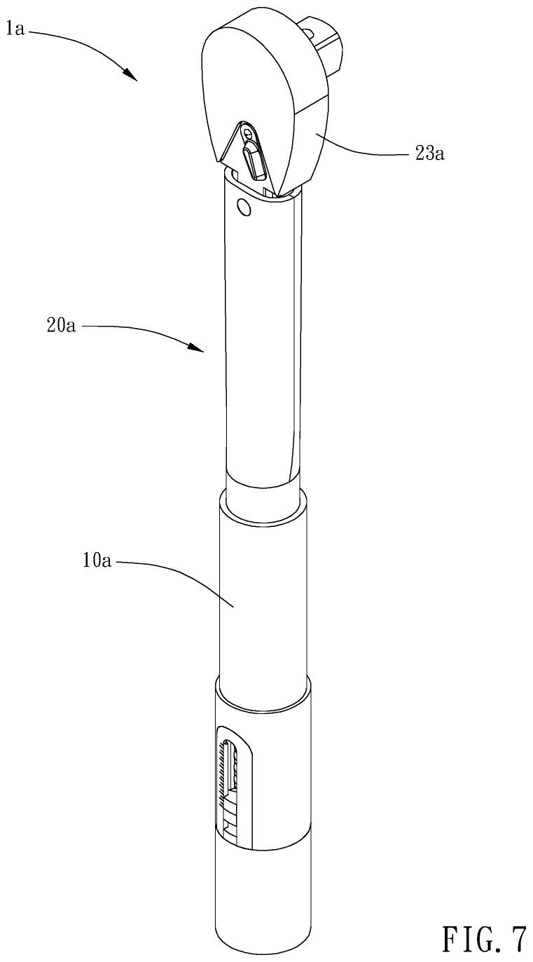

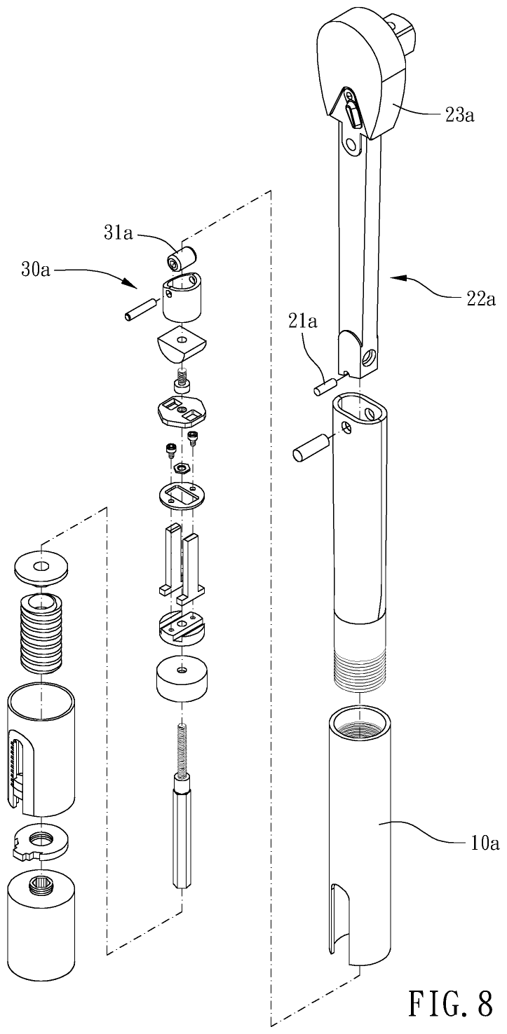

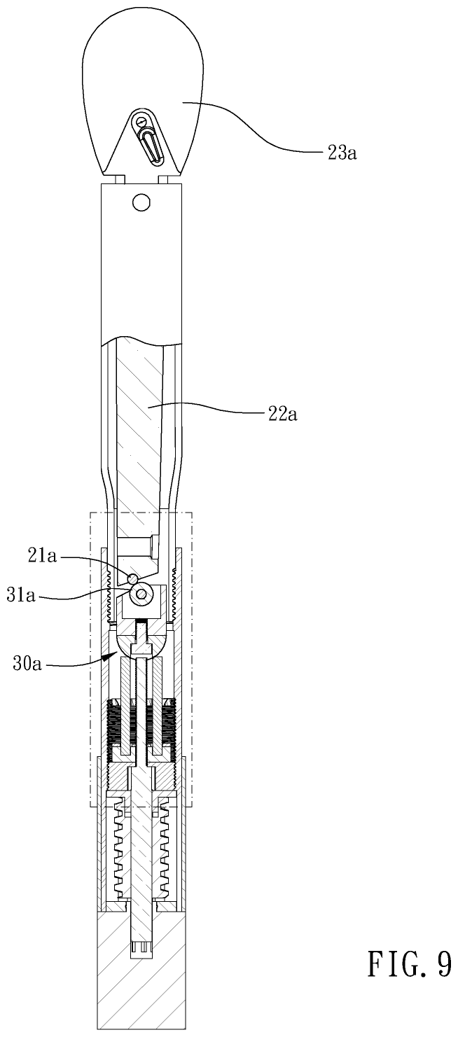

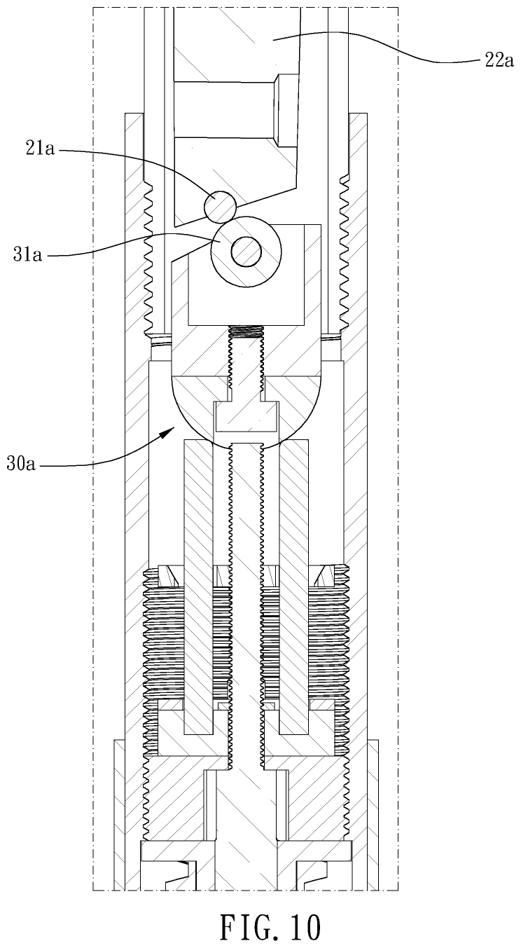

Please refer to a second preferable embodiment of the present invention shown in FIGS. 7-10. The torsion tool 1a is a torsion wrench, the first member 20a includes a rod body 22a rotatably connected to and in the barrel 10a and a working head 23a projecting out of the barrel 10a, where “rotatably” means “rotatable about an axis” or “swingable relative to an axis”. The rod body 22a includes the first engaging portion 21a, the barrel 10a serves as a handle portion of the torsion wrench and can be a member formed of one piece or multi pieces. The first engaging portion 21a and the second engaging portion 31a of the second member 30a are releasably engaged with each other, and the first engaging portion 21a and the second engaging portion 31a are preferably rollable members. The first member 20a includes a ratchet working member, and the working head 23a is a ratchet head, or a tool head for driving, extension or connection.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A torsion tool, including:
a barrel;
a first member, disposed at one end of the barrel, including at least one first engaging portion;
a second member, disposed in the barrel, including at least one second engaging portion, on a motion path of the second member, the at least one second engaging portion and the at least one first engaging portion being releasably engaged with each other;
an elastic mechanism, including a first fixation portion disposed in the barrel and a plurality of elastic arms, the plurality of elastic arms being independently fixed to the first fixation portion and corresponding to each other, the second member being located between and configured to radially expand the plurality of elastic arms;
wherein when there is a torsion force greater than a preset torque value between the at least one second engaging portion and the at least one first engaging portion, the second member urges and radially expands the plurality of elastic arms so that the at least one second engaging portion and the at least one first engaging portion are relatively slipable and disengageable.

2. The torsion tool of claim 1, wherein the second member includes an engaging member including the at least one second engaging portion and an abutting member abutted between the engaging member and the plurality of elastic arms, and the abutting member is located between and configured to radially expand the plurality of elastic arms.

3. The torsion tool of claim 2, wherein the abutting member includes an arcuate surface extending between the plurality of elastic arms.

4. The torsion tool of claim 1, wherein the first fixation portion includes a first fixation member connected to the barrel, a base located at a side of the first fixation member and a pressing member fixedly connected to the base, and each of the plurality of elastic arms includes a lateral section received in the base and clamped between the pressing member and the base.

5. The torsion tool of claim 4, wherein each of the plurality of elastic arms further includes an upright section extending toward the second member and abutting the second member, and the lateral section extends laterally from the upright section.

6. The torsion tool of claim 4, wherein the elastic mechanism further includes a threaded member and a plate member, the threaded member is disposed through the first fixation member, the base and the pressing member, the threaded member is screwed to the plate member, and the plurality of elastic arms extend toward the second member and extend through and project beyond the plate member.

7. The torsion tool of claim 6, wherein the plate member includes a plurality of through holes through which the plurality of elastic arms are disposed, and each of the plurality of through holes includes an inclined surface located between one of the plurality of elastic arms and the barrel and expands.

8. The torsion tool of claim 6, wherein the elastic mechanism further includes a nut screwed to the threaded member, and the nut is located between the plate member and the base.

9. The torsion tool of claim 7, wherein the second member includes an engaging member including the at least one second engaging portion and an abutting member abutted between the engaging member and the plurality of elastic arms, and the abutting member is located between and configured to radially expand the plurality of elastic arms; the abutting member includes an arcuate surface extending between the plurality of elastic arms; the arcuate surface is an arced surface; the base includes a plurality of grooves arranged in parallel, and the lateral section of each of the plurality of elastic arms is received in one of the plurality of grooves and flush with the base; at least one fastener fixes the pressing member to the base; the pressing member includes a penetrating hole, and the plurality of elastic arms and the threaded member are disposed through the penetrating hole; each of the plurality of elastic arms further includes an upright section extending toward the second member and abutting the second member, and the lateral section extends laterally from the upright section; the elastic mechanism further includes a nut screwed to the threaded member, and the nut is located between the plate member and the base; the nut is thinner than the pressing member and is located in the penetrating hole.

10. The torsion tool of claim 1, wherein each of the plurality of elastic arms includes a corner portion abutted against the second member.
